(19) United States
(12) Patent Application Publication
(10) Pub. No.: US 2005/0195351 A1
(43) Pub. Date: Sep. 8, 2005

(54) Multi-domain vertical alignment liquid crystal display device

(75) Inventors: Sheng-Shiou Yeh, ShenZhen (CN); Jia-Pang Pang, Miao-Li (TW); Mei-Ling Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/071,386

(22) Filed: Mar. 2, 2005

(30) Foreign Application Priority Data
Mar. 2, 2004 (CN) 2004100264237

(51) Int. Cl. G02F 1/1343

(52) U.S. Cl. 349/139

(57) ABSTRACT

An LCD device (300) includes a first substrate (30), a second substrate (40) disposed parallel to the first substrate, and a liquid crystal layer (33) having liquid crystal molecules interposed between the substrates. The first substrate includes a transparent plate (31), a color filter layer (38) formed on the transparent plate opposite to the second substrate, and a common electrode (39) formed on the color filter layer. The common electrode has a plurality of protruding portions (391) protruding toward the second substrate. The second substrate has pixel electrodes (35) opposite to the first substrate. The pixel electrodes define slits (351) therebetween. This configuration ensures to generate a symmetric electric field (E) distributing in several directions between the common and pixel electrodes so as to form several domains.

### BACKGROUND OF THE INVENTION

1. Field of the Invention

The present invention relates to liquid crystal display (LCD) devices, and more particularly to a multi-domain vertical alignment (MVA) type LCD device configured to better align liquid crystal molecules therein.

2. Description of Prior Art

Since LCD devices are thin and light, consume relatively little electrical power, and do not cause flickering, they have helped spawn product markets such as for laptop personal computers. In recent years, there has also been great demand for LCD devices to be used as computer monitors and even televisions, both of which require the LCD devices to be larger than those of laptop personal computers. Such large-sized LCD devices in particular require that an even brightness and contrast ratio prevail over the entire display surface, regardless of the observation angle.

Because the conventional TN (twisted nematic) mode LCD device cannot easily satisfy these demands, a variety of improved LCD devices have recently been developed. They include IPS (in-plane switching) mode LCD devices, optical compensation TN mode LCD devices, and MVA (multi-domain vertical alignment) mode LCD devices. In MVA mode LCD devices, each pixel is divided into multiple domains. Liquid crystal molecules of the pixel are vertically aligned when no voltage is applied, and are inclined in different directions according the domains they are in when a voltage is applied. In other words, within each pixel, the effective direction of the electric field in one domain is different from the effective direction of the electric field in a neighboring domain. Typical MVA mode LCD devices have four domains in a pixel, and employ protrusions and/or slits to form the domains.

U.S. Pat. No. 6,424,398, issued on Jul. 23, 2002, discloses an MVA LCD device. FIGS. 3-4 represent schematic, side cross-sectional views of parts of the MVA LCD device, which is designated with the numeral 200. FIG. 3 illustrates the MVA LCD device 200 when no voltage is applied, and FIG. 4 illustrates the MVA LCD device 200 when a voltage is applied.

As shown in FIG. 3, the MVA LCD device 200 includes a color filter substrate 27 and a TFT (thin film transistor) substrate 25 spaced apart from each other, and a liquid crystal layer 29 including liquid crystal molecules sandwiched between the substrates 27, 25. A protective insulating film 48 covers the TFT substrate 25, and pixel electrodes 12 having a plurality of slits 17 is formed on the protective insulating film 48. The pixel electrodes 12 and the protective insulating film 48 are covered by an alignment film 28. The color filter substrate 27 is covered by a color filter layer 51, and a common electrode 54 covers a surface of the color filter layer 51 nearest the TFT substrate 25. A plurality of protrusions 18 are formed on the common electrode 54. The protrusions 18 and the common electrode 54 are covered by another alignment film 28.

Also referring to FIG. 4, when a voltage is applied to the pixel and common electrodes 12 and 54, an electric field E₁ distributing in several directions is generated between the pixel and common electrodes 12, 54, and several domains corresponding to the directions of the electric field E₁ are thus defined. In each domain, the liquid crystal molecules twist in directions according to the electric field, for controlling a display of the MVA LCD device 200.

However, the protrusions 18 are made of a polyimide-based photo resist, which has a dielectric constant different from the common electrode 54. The different dielectric constants impair the electric field E₁ around the protrusions 18, and make the electric field E₁ asymmetrical. This phenomenon detracts from the display quality of the MVA LCD device 200.

It is desired to provide an improved MVA type LCD device which overcomes the above-described deficiencies.

### SUMMARY OF THE INVENTION

An object of the present invention to provide an MVA LCD device having a high quality, reliable display.

In order to achieve the object set out above, an MVA LCD device in accordance with the present invention includes a first substrate, a second substrate disposed parallel to the first substrate, and a liquid crystal layer having liquid crystal molecules interposed between the substrates. The first substrate includes a transparent plate, a color filter layer formed on the transparent plate opposite to the second substrate, and a common electrode formed on the color filter layer. The common electrode has a plurality of protruding portions protruding toward the second substrate. The second substrate has a plurality of pixel electrodes opposite to the first substrate. The pixel electrodes define a plurality of slits therebetween.

This configuration ensures that, in each pixel of the LCD device, a symmetric electric field distributing in several directions is generated between the pixel and common electrodes so as to form several domains. Accordingly, the MVA LCD device has a high quality, reliable display.

Other objects, advantages, and novel features of the present invention will become more apparent from the following detailed description when taken in conjunction with the accompanying drawings.

### BRIEF DESCRIPTION OF THE DRAWINGS

FIG. 1 is a schematic, side cross-sectional view of part of an LCD device according to the present invention, showing the LCD device in a passive state.

FIG. 2 is similar to FIG. 1, but showing the LCD device in an active state in which a voltage is applied thereto.

FIG. 3 is a schematic, side cross-sectional view of part of a conventional LCD device, showing the LCD device in a passive state.

FIG. 4 is a similar to FIG. 3, but showing the LCD device in an active state in which a voltage is applied thereto.

### DETAILED DESCRIPTION OF THE PRESENT INVENTION

Reference will now be made to the drawings to describe the present invention in detail.

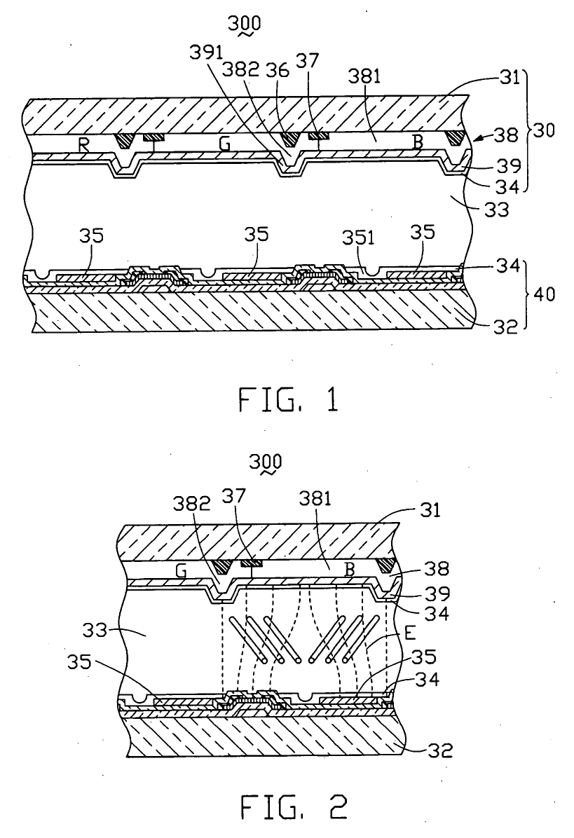

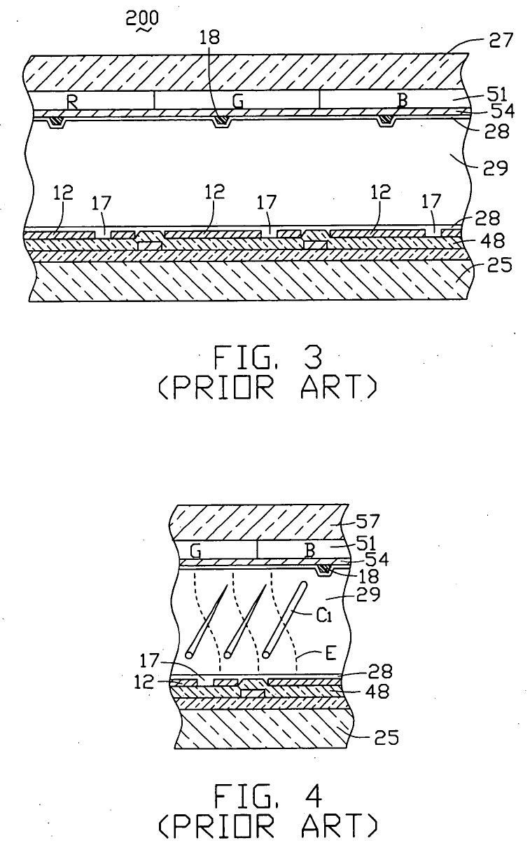

FIG. 1 is a schematic, side cross-sectional view of part of an LCD device 300 according to the present invention. The LCD device 300 includes a color filter substrate designated as a first substrate 30, a TFT (thin film transistor) substrate designated as a second substrate 40 disposed parallel to and spaced apart from the first substrate 30, and a liquid crystal layer 33 including liquid crystal molecules (not labeled) sandwiched between the substrates 30, 40. Spacers (not shown) are disposed between the substrates 30, 40 for supporting the LCD device 300 and maintaining a uniform space between the substrates 30, 40.

The first substrate 30 includes a transparent plate 31, a color filter layer 38 covering the transparent plate 31, a common electrode 39 covering the color filter layer 38, and an alignment film 34 covering the common electrode 39. The color filter layer 38 comprises a plurality of protrusions 36, a black matrix 37, and a color layer 381 composed of three color resists of R (red), G (green), and B (blue). The color layer 381 covers the black matrix 37 and the protrusions 36. The protrusions 36 are formed along with the black matrix 37 during the process of fabricating the black matrix 37. Both the protrusions 36 and the black matrix 37 are made of an acrylic resin or metallic chromium.

Sections of the color layer 381 that cover the protrusions 36 protrude toward the second substrate 40 to form protruding portions 382 in the color filter layer 38. The common electrode 39 is a transparent conductive layer, which can be made of an indium tin oxide film. Because the common electrode 39 covers the color filter layer 38, sections of the common electrode 39 integrally form protruding portions 391 that cover the protruding portions 382.

The second substrate 40 includes a transparent plate 32, an insulating layer (not labeled) covering the transparent plate 32, and a plurality of pixel electrodes 35 formed on the insulating layer. Each pixel electrode 35 is an indium tin oxide (ITO) film about 70 nm thick, and defines a plurality of slits 351 therebetween. Each pixel electrode 35 is connected to a source electrode (not labeled) of a thin film transistor. The pixel electrodes 35 are formed by DC (direct current) magnetron sputtering, and are patterned by wet etching preferably using an oxalic acid based etching process. The pixel electrodes 35 and the insulating layer are covered by an alignment film 34. Each slit 351 is disposed midway between two nearest protruding portions 391, when viewed in a direction perpendicular to the substrates 30, 40.

Also referring to FIG. 2, according to the configuration of the protruding portions 391 and the slits 351 of the first and second substrates 30 and 40 respectively, when a voltage is applied to the pixel electrodes 35 and common electrode 39, an electric field E distributing in several directions is generated between the pixel and common electrodes 35, 39 to form several domains. The liquid crystal molecules twist in different directions according to the electric field E, for controlling a display of the LCD device 300.

Unlike in the conventional LCD device 200 described above, the protrusions 36 according to the present invention are directly formed on the transparent plate 31, and are covered by the color filter layer 38 and the common electrode 39. Thus there are no intervening dielectric components between the liquid crystal molecules and the protruding portions 391 of the common electrode 39. This provides a consistent dielectric constant between the liquid crystal layer 33 and the common electrode 39. That is, in each pixel of the LCD device 300, a symmetric electric field E distributing in several directions is generated between the pixel and common electrodes 35, 39 to form several domains in the pixel. Accordingly, the LCD device 300 provides a high quality, reliable display.

It is to be understood, however, that even though numerous characteristics and advantages of the present invention have been set out in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal display device, comprising:
a first substrate, and a second substrate disposed parallel to the first substrate;
a liquid crystal layer having liquid crystal molecules interposed between the first and second substrates;
a color filter layer formed on the first substrate facing toward the second substrate;
a common electrode formed on the color filter layer, the common electrode having a plurality of protruding portions protruding toward the second substrate; and
a plurality of pixel electrodes formed at the second substrate and facing toward the first substrate, the pixel electrodes defining a plurality of slits therebetween.

2. The liquid crystal display device as claimed in claim 1, wherein an alignment film is formed on the common electrode.

3. The liquid crystal display device as claimed in claim 1, wherein each of the slits is disposed between two nearest protruding portions when viewed in a direction perpendicular to the substrates.

4. The liquid crystal display device as claimed in claim 1, wherein the color filter layer has a plurality of protruding portions corresponding to the protruding portions of the common electrode.

5. The liquid crystal display device as claimed in claim 4, wherein the first substrate comprises a plurality of protrusions, the protrusions being covered by the protruding portions of the color filter layer and the protruding portions of the common electrode.

6. The liquid crystal display device as claimed in claim 5, wherein the color filter layer further has a black matrix, and the black matrix and the protrusions are made of an acrylic resin.

7. The liquid crystal display device as claimed in claim 5, wherein the color filter layer further has a black matrix, and the black matrix and the protrusions are made of chromium.

8. A liquid crystal display device, comprising:
a first substrate, and a second substrate disposed parallel to the first substrate;
a liquid crystal layer having liquid crystal molecules interposed between the first and second substrates;
a common electrode located between the first substrate and the liquid crystal layer and defining a plurality of protruding portions protruding toward the second substrate and directly and communicatively facing the liquid crystal layer; and
a plurality of pixel electrodes formed at the second substrate and facing toward the first substrate.

9. The liquid crystal display device as claimed in claim 8, wherein pixel electrodes are configured with slits which are not aligned with the protruding portions in a vertical direction.
